(19) United States
(12) Patent Application Publication
(10) Pub. No.: US 2025/0056327 A1
(43) Pub. Date: Feb. 13, 2025

(54) Method And Apparatus For Reporting Aggregated Bandwidth Capability In Mobile Communications

(71) Applicant: MediaTek Inc., Hsinchu City (TW)

(72) Inventors: Mu-Tai Lin, Hsinchu City (TW); Chun-Fan Tsai, Hsinchu City (TW); Chia-Chun Hsu, Hsinchu City (TW)

(21) Appl. No.: 18/795,052

(22) Filed: Aug. 5, 2024

Related U.S. Application Data
(60) Provisional application No. 63/518,338, filed on Aug. 9, 2023.

(51) Int. Cl. H04W 28/20; H04L 5/00

(52) U.S. Cl. CPC H04W 28/20; H04L 5/001

(57) ABSTRACT

Various solutions for reporting aggregated bandwidth capability with respect to an apparatus in mobile communications are described. The apparatus may transmit a plurality of capability signaling of aggregated bandwidth in band combination level to a network node. Each of capability signaling of aggregated bandwidth may indicate a maximum aggregated bandwidth across component carriers. The apparatus may transmit a feature set per component-carrier, which includes channel bandwidths, to the network node for determining a channel bandwidth configuration set according to the plurality of capability signaling of aggregated bandwidth and the feature set per component-carrier. The apparatus may communicate with the network node based on the channel bandwidth configuration set.

### CROSS REFERENCE TO RELATED PATENT APPLICATION(S)

The present disclosure is part of a non-provisional application claiming the priority benefit of U.S. Patent Application No. 63/518,338, filed 9 Aug. 2023, the content of which herein being incorporated by reference in its entirety.

### TECHNICAL FIELD

The present disclosure is generally related to mobile communications and, more particularly, to reporting aggregated bandwidth capability with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, techniques of Carrier Aggregation (CA) are introduced. In current CA communications, specific configurations of Frequency Range 1 (FR1) and Frequency Range 2 (FR2) related CA band combinations are defined in 3rd Generation Partnership Project (3GPP) specifications. In addition, User Equipment (UE) capability signaling for CA band combinations is defined in 3GPP specifications as well. Based on the explicitly defined configurations and UE capability signaling related to CA band combinations, the UE may report its capability to the network node, and the network node may determine how to communicate with the UE based on the UE capability report.

Regarding the UE capability signaling for CA band combination, band combinations and corresponding feature sets constitute the primary components of signaling. However, in the current framework, signaling overhead of the UE capability signaling for CA transmitted from the UE to the network node is significantly high. For example, regarding an FR1 inter-band CA scenario, when the UE only supports an inferior aggregated bandwidth which is not equal to the maximum aggregated bandwidth implicitly specified in 3GPP specifications, the UE must report various potential fallback capabilities, which could cause considerable signaling overhead in Radio Resource Control (RRC) signaling.

Accordingly, how to decrease the signaling overhead of UE capability report for the CA communication-related operations become important issues in the newly developed wireless communication network, and there is an urgent need to provide proper schemes to decrease the signaling overhead of UE capability report and improve reporting efficiency for the CA communication-related operations.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The objective of the present disclosure is to propose solutions or schemes that address the aforementioned issues pertaining to reporting aggregated bandwidth capability with respect to apparatus in mobile communications.

In one aspect, a method may involve an apparatus transmitting a plurality of capability signaling of aggregated bandwidth in band combination level to a network node. Each of capability signaling of aggregated bandwidth may indicate a maximum aggregated bandwidth across component carriers. The method may also involve the apparatus transmitting a feature set per component-carrier, which includes channel bandwidths, to the network node for determining a channel bandwidth configuration set according to the plurality of capability signaling of aggregated bandwidth and the feature set per component-carrier. The method may further involve the apparatus communicating with the network node based on the channel bandwidth configuration set.

In one aspect, a method may involve an apparatus receiving a plurality of capability signaling of aggregated bandwidth in band combination level from a user equipment. Each of capability signaling of aggregated bandwidth may indicate a maximum aggregated bandwidth across component carriers. The method may also involve the apparatus receiving a feature set per component-carrier, which includes channel bandwidths, from the user equipment. The method may further involve the apparatus determining a channel bandwidth configuration set according to the plurality of capability signaling of aggregated bandwidth and the feature set per component-carrier. The method may further involve the apparatus communicating with the user equipment based on the channel bandwidth configuration set.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising transmitting, via the transceiver, a plurality of capability signaling of aggregated bandwidth in band combination level to the network node. Each of capability signaling of aggregated bandwidth may indicate a maximum aggregated bandwidth across component carriers. The processor may also perform operations comprising transmitting, via the transceiver, a feature set per component-carrier, which includes channel bandwidths, to the network node for determining a channel bandwidth configuration set according to the plurality of capability signaling of aggregated bandwidth and the feature set per component-carrier. The processor may further perform operations comprising communicating with the network node based on the channel bandwidth configuration set.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reporting aggregated bandwidth capability with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a user equipment (UE) compatible with carrier aggregation (CA) techniques may transmit a plurality of capability signaling of aggregated bandwidth in band combination (BC) level to a network node. In particular, regarding to BC level, each of the capability signaling of aggregated bandwidth may indicate a maximum aggregated bandwidth across component carriers (CCs). Regarding to feature set per component-carrier (FSPC) level, the UE may transmit an FSPC to the network node. The FSPC may include at least one set of channel bandwidths supported by the UE for CA.

Based on the maximum aggregated bandwidth indicated by the plurality of capability signaling of aggregated bandwidth and the FSPC, the network node may determine a channel bandwidth configuration set. The channel bandwidth configuration set may include actual bandwidths utilized in the channels. The network node may configure the UE the channel bandwidth configuration set and communicate with the UE based on the channel bandwidth configuration set. More specifically, based on the maximum aggregated bandwidth indicated by the plurality of capability signaling of aggregated bandwidth, the network node may determine suitable channel bandwidths for communicating with the UE, and the UE does not need to report various potential fallback capabilities, which could cause considerable signaling overhead in Radio Resource Control (RRC) signaling. Accordingly, in some cases, especially the cases that the UE radio access capabilities are bounded to be lower than corresponding CA configurations defined in 3GPP specification, the signaling overhead in the CA communications may be significantly decreased.

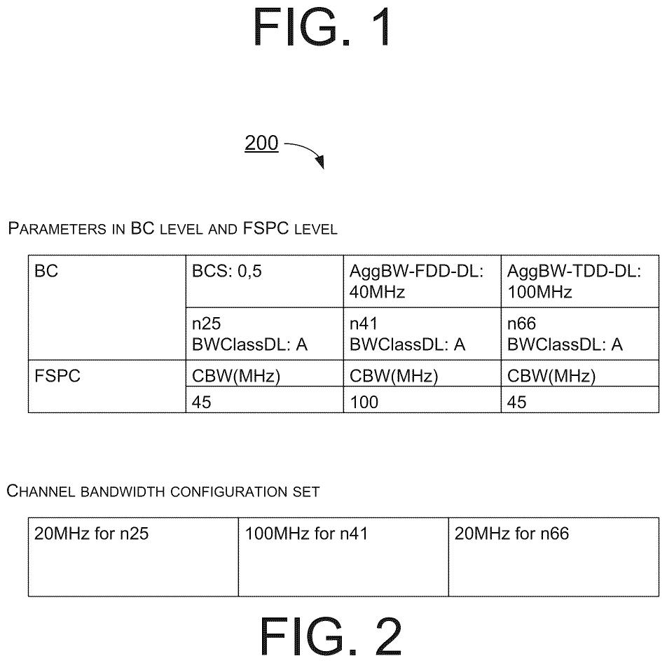

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the UE may transmit a plurality of capability signaling in BC level to the network node. Each of capability signaling of aggregated bandwidth may indicate a maximum aggregated bandwidth across CCs. The UE may transmit a capability signaling in FSPC level (i.e., the UE may transmit FSPC) to the network node. The FSPC may include channel bandwidths. The network node may determine a channel bandwidth configuration set according to the plurality of capability signaling of aggregated bandwidth and the FSPC. The network node may configure the UE the channel bandwidth configuration set and communicate with the UE based on the channel bandwidth configuration set.

In some implementations, the plurality of capability signaling of aggregated bandwidth and the FSPC may be used for downlink (DL) communication. The plurality of capability signaling of aggregated bandwidth may include: (1) a capability signaling of frequency division duplexing (FDD) aggregated bandwidth indicating a maximum aggregated bandwidth of a plurality of maximum aggregated bandwidths across FDD CCs; and (2) a capability signaling of time division duplexing (TDD) aggregated bandwidth indicating a maximum aggregated bandwidth of a plurality of maximum aggregated bandwidths across TDD CCs.

For example, please refer to FIG. 2 which illustrates an example scenario 200 under schemes in accordance with implementations of the present disclosure. Regarding DL CA of channels n25, n41 and n66, there are: (a) parameters in BC level; and (b) parameters in FSPC level. In section of BC level, the parameters include: (1) bandwidth combination set BCS indicating #0 (zeroth), #5 (fifth) bandwidth combination sets are supported; (2) channel n25 bandwidth class BWClassDL indicating A; (3) channel n41 bandwidth class BWClassDL indicating A; (4) channel n66 bandwidth class BWClassDL indicating A; (5) the capability signaling of FDD aggregated bandwidth AggBW-FDD-DL indicating the supported maximum aggregated bandwidth 40 MHz across FDD downlink CCs; and (6) the capability signaling of TDD aggregated bandwidth AggBW-TDD-DL indicating the supported maximum aggregated bandwidth 100 MHz across TDD downlink CCs. In section of FSPC level, capability parameters include: (1) channel bandwidth CBW 45 MHz for channel n25; (2) channel bandwidth CBW 100 MHz for channel n41; and (3) channel bandwidth CBW 45 MHz for channel n66.

Accordingly, after receiving the capability parameters in BC level and the parameters in FSPC level from the UE, the network node determines the channel bandwidth configuration set including bandwidth 20 MHz for channel n25 (which is an FDD channel,) bandwidth 100 MHz for channel n41 (which is a TDD channel,) and bandwidth 20 MHz for channel n66 (which is an FDD channel) under the condition that the following requirements are met: (1) the total FDD bandwidth (i.e., aggregating 20 MHz for channel n25 and 20 MHz for channel n66) should be less than or equal to the supported maximum aggregated FDD bandwidths 40 MHz (indicated by the capability signaling of FDD aggregated bandwidth AggBW-FDD-DL); and (2) the total TDD (i.e., 100 MHz for channel n41) bandwidth should be less than or equal to the supported maximum aggregated TDD bandwidths 100 MHZ (indicated by the capability signaling of TDD aggregated bandwidth AggBW-TDD-DL.) The network node and the UE perform CA communication based on the channel bandwidth configuration set.

In some implementations, the plurality of capability signaling of aggregated bandwidth and the FSPC may be used for DL communication. The plurality of capability signaling of aggregated bandwidth may include: (1) a capability signaling of FDD aggregated bandwidth indicating a maximum aggregated bandwidth of a plurality of maximum aggregated bandwidths across FDD CCs; (2) a capability signaling of TDD aggregated bandwidth indicating a maximum aggregated bandwidth of a plurality of maximum aggregated bandwidths across TDD CCs; and (3) a capability signaling of total aggregated bandwidth indicating a maximum total aggregated bandwidth of a plurality of maximum aggregated bandwidths across all CCs.

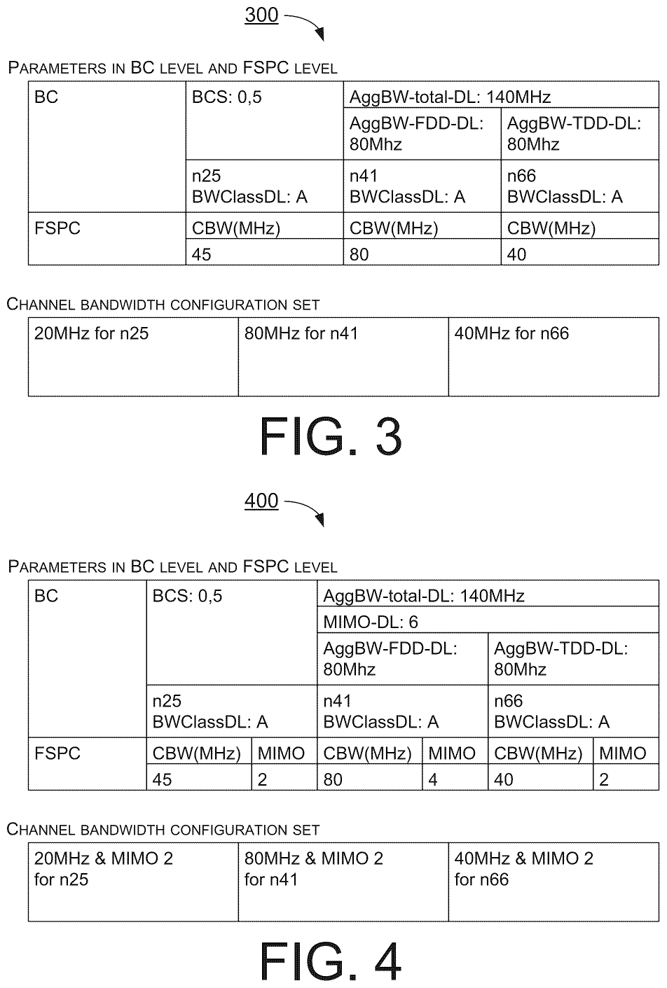

For example, please refer to FIG. 3 which illustrates an example scenario 300 under schemes in accordance with implementations of the present disclosure. Regarding DL CA of channels n25, n41 and n66, there are: (a) parameters in BC level; and (b) parameters in FSPC level. In section of BC level, the parameters include: (1) bandwidth combination set BCS indicating #0 (zeroth), #5 (fifth) bandwidth combination sets are supported; (2) channel n25 bandwidth class BWClassDL indicating A; (3) channel n41 bandwidth class BWClassDL indicating A; (4) channel n66 bandwidth class BWClassDL indicating A; (5) the capability signaling of total aggregated bandwidth AggBW-total-DL indicating the supported maximum aggregated total bandwidths 140 MHz across all CCs; (6) the capability signaling of FDD aggregated bandwidth AggBW-FDD-DL indicating the supported maximum aggregated FDD bandwidths 80 MHz across CCs; and (7) the capability signaling of TDD aggregated bandwidth AggBW-TDD-DL indicating the supported maximum aggregated TDD bandwidths 80 MHz across CCs. In section of FSPC level, parameters include: (1) channel bandwidth CBW 45 MHz for channel n25; (2) channel bandwidth CBW 80 MHz for channel n41; and (3) channel bandwidth CBW 40 MHz for channel n66.

Accordingly, after receiving the parameters in BC level and the parameters in FSPC level from the UE, the network node determines the channel bandwidth configuration set including bandwidth 20 MHz for channel n25 (which is an FDD channel,) bandwidth 80 MHz for channel n41 (which is a TDD channel,) and bandwidth 40 MHz for channel n66 (which is an FDD channel) under the condition that the following requirements are met: (1) the total FDD bandwidth (i.e., aggregating 20 MHz for channel n25 and 40 MHz for channel n66) should be less than or equal to the supported maximum aggregated FDD bandwidths 80 MHZ (indicated by the capability signaling of FDD aggregated bandwidth AggBW-FDD-DL); (2) the total TDD bandwidth (i.e., 80 MHz for channel n41) should be less than or equal to the supported maximum aggregated TDD bandwidths 80 MHZ (indicated by the capability signaling of TDD aggregated bandwidth AggBW-TDD-DL); and (3) the total bandwidth (i.e., aggregating 20 MHz for channel n25, 80 MHz for channel n41 and 40 MHz for channel n66) should be less than or equal to the supported maximum total aggregated bandwidths 140 MHz (indicated by the capability signaling of total aggregated bandwidth AggBW-total-DL.) The network node and the UE perform CA communication based on the channel bandwidth configuration set.

Through the invention, there may be pairs of aggregated FDD bandwidth and aggregated TDD bandwidths implicitly derived from the aggregated bandwidth signaling. Some pairs may be supported but some pairs may be not supported. Please refer to below table as example. In this example, the supported maximum total aggregated bandwidth is 140 MHz, and there are six pairs of aggregated FDD bandwidth and aggregated TDD bandwidths. In the six pairs of aggregated FDD bandwidth and aggregated TDD bandwidth, first, second and sixth pairs cannot be supported because: (1) in the first pair, 100 MHz TDD bandwidth is over the supported maximum aggregated TDD bandwidths 80 MHz; (2) in the second pair, 90 MHz TDD bandwidth is over the supported maximum aggregated TDD bandwidth 80 MHz; and (3) in the sixth pair, 90 MHz FDD bandwidth is over the supported maximum aggregated FDD bandwidth 80 MHz.

Supported total aggregated bandwidth: 140 MHz

| Supported FDD aggregated | | Supported TDD aggregated | |
|---|---|---|---|
| bandwidth: 80 MHz | | bandwidth: 80 MHz | |
| Pair No. of possible FDD + | Aggregated FDD | | Aggregated FDD |
| TDD bandwidth combinations | bandwidth (MHz) | | bandwidth (MHz) |
| 1 (not supported) | 40 | | 100 |
| 2 (not supported) | 50 | | 90 |
| 3 | 60 | | 80 |
| 4 | 70 | | 70 |
| 5 | 80 | | 60 |
| 6 (not supported) | 90 | | 50 |

In some implementations, the plurality of capability signaling of aggregated bandwidth and the FSPC may be used for DL communication. The plurality of capability signaling of aggregated bandwidth may include: (1) a capability signaling of FDD aggregated bandwidth indicating a maximum aggregated bandwidth of a plurality of maximum aggregated bandwidths across FDD CCs; (2) a capability signaling of TDD aggregated bandwidth indicating a maximum aggregated bandwidth of a plurality of maximum aggregated bandwidths across TDD CCs; (3) a capability signaling of total aggregated bandwidth indicating a maximum total aggregated bandwidth of a plurality of maximum aggregated bandwidths across all CCs; and (4) a capability signaling of multi-input multi-output (MIMO) indicating a maximum number of spatial multiplexing layers. It should be noted that the maximum number of spatial multiplexing layers may be a parameter (e.g., maxNumberMIMO-LayersPDSCH defined in 3GPP specification) of maximum number of spatial multiplexing layers supported by the UE for DL reception.

For example, please refer to FIG. 4 which illustrates an example scenario 400 under schemes in accordance with implementations of the present disclosure. Regarding DL CA of channels n25, n41 and n66, there are: (a) parameters in BC level; and (b) parameters in FSPC level. In section of BC level, the parameters include: (1) bandwidth combination set BCS indicating #0 (zeroth), #5 (fifth) bandwidth combination sets are supported; (2) channel n25 bandwidth class BWClassDL indicating A; (3) channel n41 bandwidth class BWClassDL indicating A; (4) channel n66 bandwidth class BWClassDL indicating A; (5) the capability signaling of total aggregated bandwidth AggBW-total-DL indicating the supported maximum aggregated total bandwidths 140 MHz across all CCs; (6) the capability signaling of FDD aggregated bandwidth AggBW-FDD-DL indicating the supported maximum aggregated bandwidth 80 MHz across FDD CCs; (7) the capability signaling of TDD aggregated bandwidth AggBW-TDD-DL indicating the supported maximum aggregated bandwidth 80 MHz across TDD CCs; and (8) the capability signaling of MIMO MIMO-DL indicating the maximum number of spatial multiplexing layers 6. In section of FSPC level, parameters include: (1) channel bandwidth CBW 45 MHz and MIMO indicating spatial multiplexing layers 2 for channel n25; (2) channel bandwidth CBW 80 MHz and MIMO indicating spatial multiplexing layers 4 for channel n41; and (3) channel bandwidth CBW 40 MHz and MIMO indicating spatial multiplexing layers 2 for channel n66.

Accordingly, after receiving the parameters in BC level and the parameters in FSPC level from the UE, the network node determines the channel bandwidth configuration set including bandwidth 20 MHz and MIMO indicating spatial multiplexing layers 2 for channel n25 (which is an FDD channel,) bandwidth 80 MHz and MIMO indicating spatial multiplexing layers 2 for channel n41 (which is a TDD channel,) and bandwidth 40 MHz and MIMO indicating spatial multiplexing layers 2 for channel n66 (which is an FDD channel) under the condition that the following requirements are met: (1) the total FDD bandwidth (i.e., aggregating 20 MHz for channel n25 and 40 MHz for channel n66) should be less than or equal to the supported maximum aggregated FDD bandwidths 80 MHZ (indicated by the capability signaling of FDD aggregated bandwidth AggBW-FDD-DL); (2) the total TDD bandwidth (i.e., 80 MHz for channel n41) should be less than or equal to the supported maximum aggregated TDD bandwidths 80 MHz (indicated by the capability signaling of TDD aggregated bandwidth AggBW-TDD-DL); (3) the total bandwidth (i.e., aggregating 20 MHz for channel n25, 80 MHz for channel n41 and 40 MHz for channel n66) should be less than or equal to the supported maximum aggregated bandwidth 140 MHZ (indicated by the capability signaling of total aggregated bandwidth AggBW-total-DL); and (4) the total spatial multiplexing layers number (i.e., MIMO indicating spatial multiplexing layers 2 for channel n25, MIMO indicating spatial multiplexing layers 2 for channel n41 and MIMO indicating spatial multiplexing layers 2 for channel n66) should be less than or equal to the supported maximum number of spatial multiplexing layers 6 (indicated by the capability signaling of MIMO MIMO-DL.) The network node and the UE perform CA communication based on the channel bandwidth configuration set.

In some implementations, the plurality of capability signaling of aggregated bandwidth and the FSPC may be used for uplink (UL) communication. The plurality of capability signaling of aggregated bandwidth may include: (1) a capability signaling of FDD aggregated bandwidth indicating a maximum aggregated bandwidth of a plurality of maximum aggregated bandwidths across FDD CCs; and (2) a capability signaling of TDD aggregated bandwidth indicating a maximum aggregated bandwidth of a plurality of maximum aggregated bandwidths across TDD CCs.

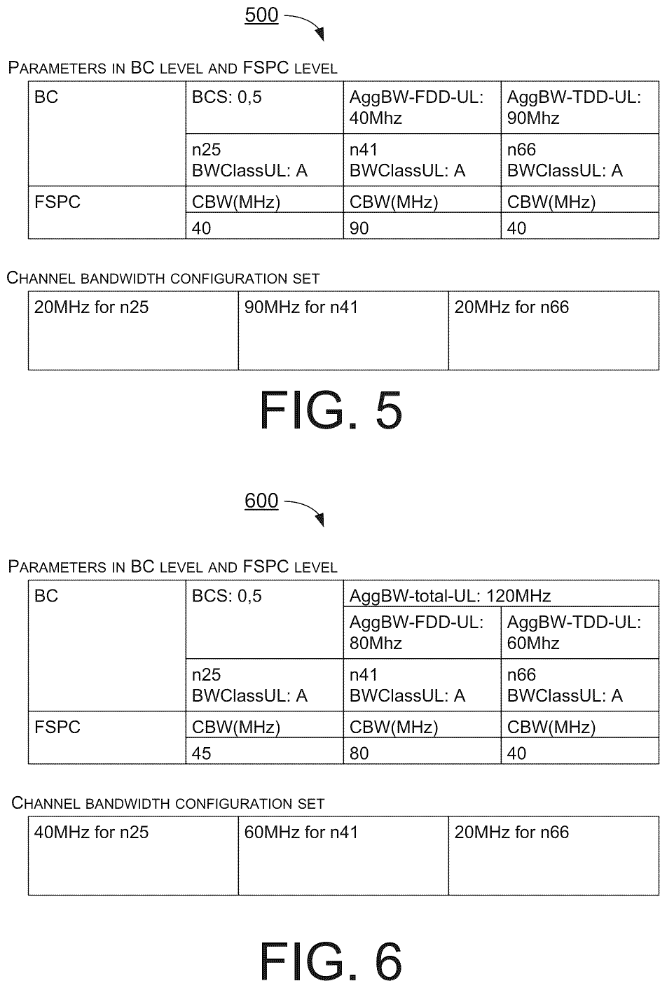

For example, please refer to FIG. 5 which illustrates an example scenario 500 under schemes in accordance with implementations of the present disclosure. Regarding UL CA of channels n25, n41 and n66, there are: (a) parameters in BC level; and (b) parameters in FSPC level. In section of BC level, the parameters include: (1) bandwidth combination set BCS indicating #0 (zeroth), #5 (fifth) bandwidth combination sets are supported; (2) channel n25 bandwidth class BWClassUL indicating A; (3) channel n41 bandwidth class BWClassUL indicating A; (4) channel n66 bandwidth class BWClassUL indicating A; (5) the capability signaling of FDD aggregated bandwidth AggBW-FDD-UL indicating the supported maximum aggregated bandwidth 40 MHz across FDD CCs; and (6) the capability signaling of TDD aggregated bandwidth AggBW-TDD-UL indicating the supported maximum aggregated bandwidth 90 MHz across TDD CCs. In section of FSPC level, parameters include: (1) channel bandwidth CBW 40 MHz for channel n25; (2) channel bandwidth CBW 90 MHz for channel n41; and (3) channel bandwidth CBW 40 MHz for channel n66.

Accordingly, after receiving the parameters in BC level and the parameters in FSPC level from the UE, the network node determines the channel bandwidth configuration set including bandwidth 20 MHz for channel n25 (which is an FDD channel,) bandwidth 90 MHz for channel n41 (which is a TDD channel,) and bandwidth 20 MHz for channel n66 (which is an FDD channel) under the condition that the following requirements are met: (1) the total FDD bandwidth (i.e., aggregating 20 MHz for channel n25 and 20 MHz for channel n66) should be less than or equal to the supported maximum aggregated FDD bandwidths 40 MHZ (indicated by the capability signaling of FDD aggregated bandwidth AggBW-FDD-UL); and (2) the total TDD bandwidth (i.e., 90 MHz for channel n41) should be less than or equal to the supported maximum aggregated TDD bandwidths 90 MHz (indicated by the capability signaling of TDD aggregated bandwidth AggBW-TDD-UL.) The network node and the UE perform CA communication based on the channel bandwidth configuration set.

In some implementations, the plurality of capability signaling of aggregated bandwidth and the FSPC may be used for UL communication. The plurality of capability signaling of aggregated bandwidth may include: (1) a capability signaling of FDD aggregated bandwidth indicating a maximum aggregated bandwidth of a plurality of maximum aggregated bandwidths across FDD CCs; (2) a capability signaling of TDD aggregated bandwidth indicating a maximum aggregated bandwidth of a plurality of maximum aggregated bandwidths across TDD CCs; and (3) a capability signaling of total aggregated bandwidth indicating a maximum total aggregated bandwidth of a plurality of maximum aggregated bandwidths across all CCs.

For example, please refer to FIG. 6 which illustrates an example scenario 600 under schemes in accordance with implementations of the present disclosure. Regarding UL CA of channels n25, n41 and n66, there are: (a) parameters in BC level; and (b) parameters in FSPC level. In section of BC level, the parameters include: (1) bandwidth combination set BCS indicating #0 (zeroth), #5 (fifth) bandwidth combination sets are supported; (2) channel n25 bandwidth class BWClassUL indicating A; (3) channel n41 bandwidth class BWClassUL indicating A; (4) channel n66 bandwidth class BWClassUL indicating A; (5) the capability signaling of total aggregated bandwidth AggBW-total-UL indicating the supported maximum aggregated total bandwidths 120 MHz across all CCs; (6) the capability signaling of FDD aggregated bandwidth AggBW-FDD-UL indicating the supported maximum aggregated bandwidth 80 MHz across FDD CCs; and (7) the capability signaling of TDD aggregated bandwidth AggBW-TDD-DL indicating the maximum aggregated bandwidth 60 MHz across TDD CCs. In section of FSPC level, parameters include: (1) channel bandwidth CBW 45 MHz for channel n25; (2) channel bandwidth CBW 80 MHz for channel n41; and (3) channel bandwidth CBW 40 MHz for channel n66.

Accordingly, after receiving the parameters in BC level and the parameters in FSPC level from the UE, the network node determines the channel bandwidth configuration set including bandwidth 40 MHz for channel n25 (which is an FDD channel,) bandwidth 60 MHz for channel n41 (which is a TDD channel,) and bandwidth 20 MHz for channel n66 (which is an FDD channel) under the condition that the following requirements are met: (1) the total FDD bandwidth (i.e., aggregating 40 MHz for channel n25 and 20 MHz for channel n66) should be less than or equal to the supported maximum aggregated FDD bandwidths 80 MHZ (indicated by the capability signaling of FDD aggregated bandwidth AggBW-FDD-UL); (2) the total TDD bandwidth (i.e., 60 MHz for channel n41) should be less than or equal to the supported maximum aggregated TDD bandwidths 60 MHz (indicated by the capability signaling of TDD aggregated bandwidth AggBW-TDD-UL); and (3) the total bandwidth (i.e., 40 MHz for channel n25, 60 MHz for channel n41 and 20 MHz for channel n66) should be less than or equal to the supported maximum total aggregated bandwidths 120 MHZ (indicated by the capability signaling of total aggregated bandwidth AggBW-total-UL.) The network node and the UE perform CA communication based on the channel bandwidth configuration set.

In some implementations, the plurality of capability signaling of aggregated bandwidth and the FSPC may be used for UL communication. The plurality of capability signaling of aggregated bandwidth may include: (1) a capability signaling of FDD aggregated bandwidth indicating a maximum aggregated bandwidth of a plurality of maximum aggregated bandwidths across FDD CCs; (2) a capability signaling of TDD aggregated bandwidth indicating a maximum aggregated bandwidth of a plurality of maximum aggregated bandwidths across TDD CCs; (3) a capability signaling of total aggregated bandwidth indicating a maximum total aggregated bandwidth of a plurality of maximum aggregated bandwidths across all CCs; and (4) a capability signaling of MIMO indicating a maximum number of indicating spatial multiplexing layers.

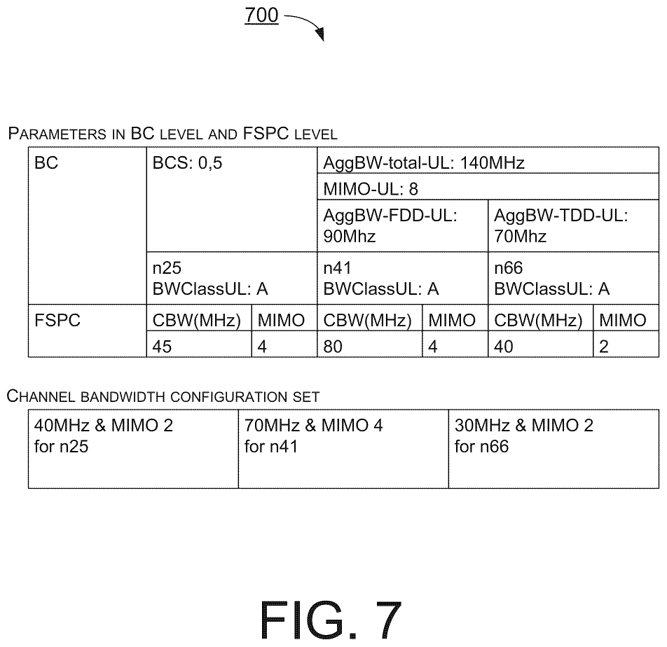

For example, please refer to FIG. 7 which illustrates an example scenario 700 under schemes in accordance with implementations of the present disclosure. Regarding UL CA of channels n25, n41 and n66, there are: (a) parameters in BC level; and (b) parameters in FSPC level. In section of BC level, the parameters include: (1) bandwidth combination set BCS indicating #0 (zeroth), #5 (fifth) bandwidth combination sets are supported; (2) channel n25 bandwidth class BWClassUL indicating A; (3) channel n41 bandwidth class BWClassUL indicating A; (4) channel n66 bandwidth class BWClassUL indicating A; (5) the capability signaling of total aggregated bandwidth AggBW-total-UL indicating the maximum aggregated total bandwidths 140 MHz across all CCs; (6) the capability signaling of FDD aggregated bandwidth AggBW-FDD-UL indicating the maximum aggregated bandwidth 90 MHz across FDD uplink CCs; (7) the capability signaling of TDD aggregated bandwidth AggBW-TDD-UL indicating the maximum aggregated bandwidth 70 MHz across TDD uplink CCs; and (8) the capability signaling of MIMO MIMO-UL indicating the maximum number of indicating spatial multiplexing layers 8 across CCs. In section of FSPC level, parameters include: (1) channel bandwidth CBW 45 MHz and MIMO indicating spatial multiplexing layers 4 for channel n25; (2) channel bandwidth CBW 80 MHz and MIMO indicating spatial multiplexing layers 4 for channel n41; and (3) channel bandwidth CBW 40 MHz and MIMO indicating spatial multiplexing layers 2 for channel n66.

Accordingly, after receiving the parameters in BC level and the parameters in FSPC level from the UE, the network node determines the channel bandwidth configuration set including bandwidth 40 MHz and MIMO indicating spatial multiplexing layers 2 for channel n25 (which is an FDD channel,) bandwidth 70 MHz and MIMO indicating spatial multiplexing layers 4 for channel n41 (which is a TDD channel,) and bandwidth 30 MHz and MIMO indicating spatial multiplexing layers 2 for channel n66 (which is an FDD channel) under the condition that the following requirements are met: (1) the total FDD bandwidth (i.e., aggregating 40 MHz for channel n25 and 30 MHz for channel n66) should be less than or equal to the supported maximum aggregated FDD bandwidths 90 MHz (indicated by the capability signaling of FDD aggregated bandwidth AggBW-FDD-UL); (2) the total TDD bandwidth (i.e., 70 MHz for channel n41) should be less than or equal to the supported maximum aggregated TDD bandwidths 70 MHz (indicated by the capability signaling of TDD aggregated bandwidth AggBW-TDD-UL); (3) the total bandwidth (i.e., aggregating 40 MHz for channel n25, 70 MHz for channel n41 and 30 MHz for channel n66) should be less than or equal to the supported maximum aggregated bandwidth 140 MHZ (indicated by the capability signaling of total aggregated bandwidth AggBW-total-UL); and (4) the total spatial multiplexing layers number (i.e., MIMO indicating spatial multiplexing layers 2 for channel n25, MIMO indicating spatial multiplexing layers 4 for channel n41 and MIMO indicating spatial multiplexing layers 2 for channel n66) should be less than or equal to the supported maximum number of spatial multiplexing layers 8 (indicated by the capability signaling of MIMO MIMO-UL.) The network node and the UE perform CA communication based on the channel bandwidth configuration set.

It should be noted that some parameters in BC level and some parameters in FSPC level mentioned in above paragraphs may have been specified in 3GPP specification, e.g., bandwidth combination set BCS, CA bandwidth class BWClassDL, bandwidth class BWClassUL and channel bandwidth CBW, and therefore are not further described in the present disclosure.

### Illustrative Implementations

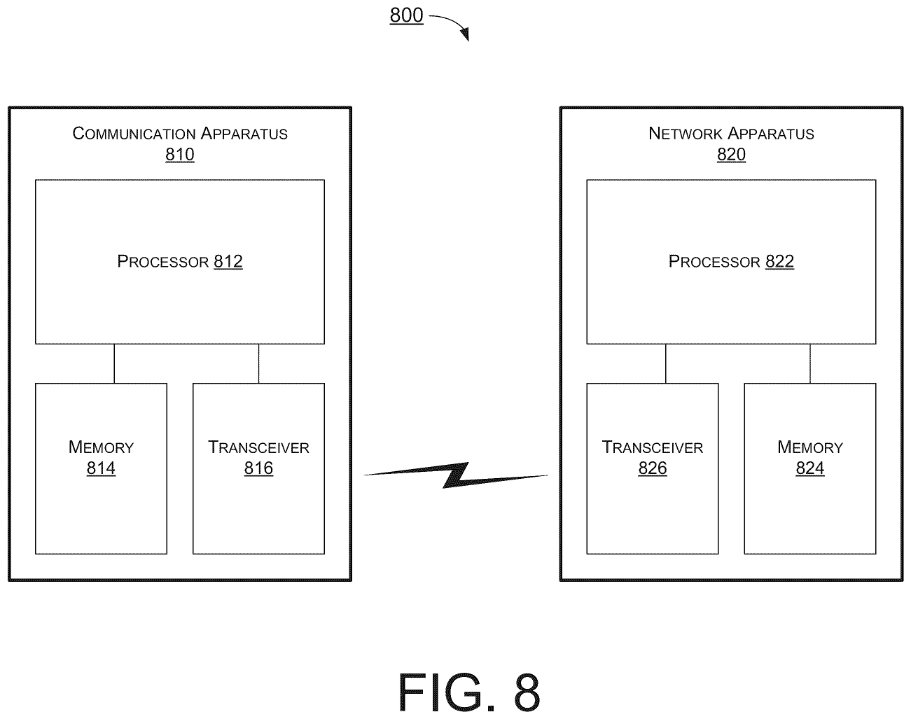

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to reporting aggregated bandwidth capability with respect to user equipment and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT or IIoT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including reporting aggregated bandwidth capability in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, processor 812 may transmit, by transceiver 816, a plurality of capability signaling of aggregated bandwidth in BC level to network apparatus 820. Each of capability signaling of aggregated bandwidth may indicate a maximum aggregated bandwidth across CCs. Processor 812 may transmit, via transceiver 816, an FSPC, which includes channel bandwidths, to network apparatus 820 for network apparatus 820 to determine a channel bandwidth configuration set according to the plurality of capability signaling of aggregated bandwidth and the FSPC. Processor 812 may communicate, via transceiver 816, with network apparatus 820 based on the channel bandwidth configuration set.

In some implementations, the plurality of capability signaling of aggregated bandwidth may include a capability signaling of TDD aggregated bandwidth. The capability signaling of TDD aggregated bandwidth may indicate a maximum aggregated bandwidth of a plurality of maximum aggregated bandwidths across TDD CCs.

In some implementations, the plurality of capability signaling of aggregated bandwidth may include a capability signaling of FDD aggregated bandwidth. The capability signaling of FDD aggregated bandwidth may indicate a maximum aggregated bandwidth of a plurality of maximum aggregated bandwidths across FDD CCs.

In some implementations, the plurality of capability signaling of aggregated bandwidth may include a capability signaling of total aggregated bandwidth. The capability signaling of total aggregated bandwidth may indicate a maximum total aggregated bandwidth of a plurality of maximum aggregated bandwidths across all CCs.

In some implementations, the plurality of capability signaling of aggregated bandwidth and the FSPC may be used for UL communication.

In some implementations, the plurality of capability signaling of aggregated bandwidth and the FSPC may be used for DL communication.

In some implementations, processor 812 may transmit, via transceiver 816, a capability signaling of MIMO to network apparatus 820. The capability signaling of MIMO indicates a maximum number of spatial multiplexing layers. Processor 812 may transmit, via transceiver 816, the FSPC, which includes the channel bandwidths and spatial multiplexing layers, to network apparatus 820 for network apparatus 820 to determine the channel bandwidth configuration set according to the plurality of capability signaling of aggregated bandwidth, the capability signaling of MIMO and the FSPC.

In some implementations, processor 822 may receive, by transceiver 826, a plurality of capability signaling of aggregated bandwidth in BC level from communication apparatus 810. Each of capability signaling of aggregated bandwidth may indicate a maximum aggregated bandwidth across CCs. Processor 822 may receive, by transceiver 826, an FSPC, which includes channel bandwidths, from communication apparatus 810. Processor 822 may determine a channel bandwidth configuration set according to the plurality of capability signaling of aggregated bandwidth and the FSPC. Processor 822 may communicate, via transceiver 826, with communication apparatus 810 according to the channel bandwidth configuration set.

In some implementations, the plurality of capability signaling of aggregated bandwidth may include a capability signaling of TDD aggregated bandwidth. The capability signaling of TDD aggregated bandwidth may indicate a maximum aggregated bandwidth of a plurality of maximum aggregated bandwidths across TDD CCs.

In some implementations, the plurality of capability signaling of aggregated bandwidth may include a capability signaling of FDD aggregated bandwidth. The capability signaling of FDD aggregated bandwidth may indicate a maximum aggregated bandwidth of a plurality of maximum aggregated bandwidths across FDD CCs.

In some implementations, the plurality of capability signaling of aggregated bandwidth may include a capability signaling of total aggregated bandwidth. The capability signaling of total aggregated bandwidth may indicate a maximum total aggregated bandwidth of a plurality of maximum aggregated bandwidths across all CCs.

In some implementations, the plurality of capability signaling of aggregated bandwidth and the FSPC may be used for UL communication.

In some implementations, the plurality of capability signaling of aggregated bandwidth and the FSPC may be used for DL communication.

In some implementations, processor 822 may receive, via transceiver 826, a capability signaling of MIMO from communication apparatus 810. The capability signaling of MIMO indicates a maximum number of spatial multiplexing layers. Processor 822 may receive, via transceiver 826, the FSPC, which includes the channel bandwidths and spatial multiplexing layers, from communication apparatus 810. Processor 822 may determine the channel bandwidth configuration set according to the plurality of capability signaling of aggregated bandwidth, the capability signaling of MIMO and the FSPC.

### Illustrative Processes

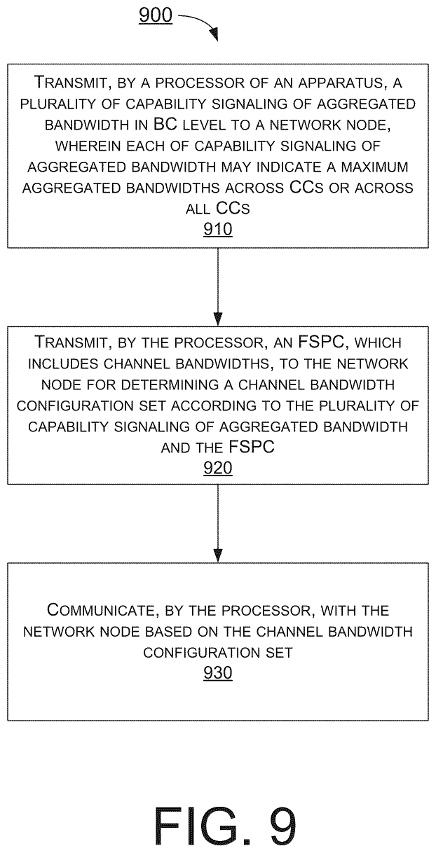

FIG. 9 illustrates an example process 900 in accordance with an implementation of the present disclosure. Process 900 may be an example implementation of above scenarios/schemes, whether partially or completely, with respect to reporting aggregated bandwidth capability of the present disclosure. Process 900 may represent an aspect of implementation of features of communication apparatus 910. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 transmitting a plurality of capability signaling of aggregated bandwidth in BC level to a network node. Each of capability signaling of aggregated bandwidth may indicate a maximum aggregated bandwidth across CCs. Process 900 may proceed from block 910 to block 920.

At block 920, process 900 may involve processor 812 of communication apparatus 810 transmitting an FSPC, which includes channel bandwidths, to the network node for determining a channel bandwidth configuration set according to the plurality of capability signaling of aggregated bandwidth and the FSPC. Process 900 may proceed from block 920 to block 930.

At block 930, process 900 may involve processor 812 of communication apparatus 810 communicating with the network node based on the channel bandwidth configuration set.

In some implementations, the plurality of capability signaling of aggregated bandwidth may include a capability signaling of TDD aggregated bandwidth. The capability signaling of TDD aggregated bandwidth may indicate a maximum aggregated bandwidth of a plurality of maximum aggregated bandwidths across TDD CCs.

In some implementations, the plurality of capability signaling of aggregated bandwidth may include a capability signaling of FDD aggregated bandwidth. The capability signaling of FDD aggregated bandwidth may indicate a maximum aggregated bandwidth of a plurality of maximum aggregated bandwidths across FDD CCs.

In some implementations, the plurality of capability signaling of aggregated bandwidth may include a capability signaling of total aggregated bandwidth. The capability signaling of total aggregated bandwidth may indicate a maximum total aggregated bandwidth of a plurality of maximum aggregated bandwidths across all CCs.

In some implementations, the plurality of capability signaling of aggregated bandwidth and the FSPC may be used for UL communication.

In some implementations, the plurality of capability signaling of aggregated bandwidth and the FSPC may be used for DL communication.

In some implementations, process 900 may involve processor 812 of communication apparatus 810 transmitting a capability signaling of MIMO to the network node. The capability signaling of MIMO may indicate a maximum spatial multiplexing layer. Process 900 may involve processor 812 of communication apparatus 810 transmitting the FSPC, which includes the channel bandwidths and spatial multiplexing layers, to the network node for determining the channel bandwidth configuration set according to the plurality of capability signaling of aggregated bandwidth, the capability signaling of MIMO and the FSPC.

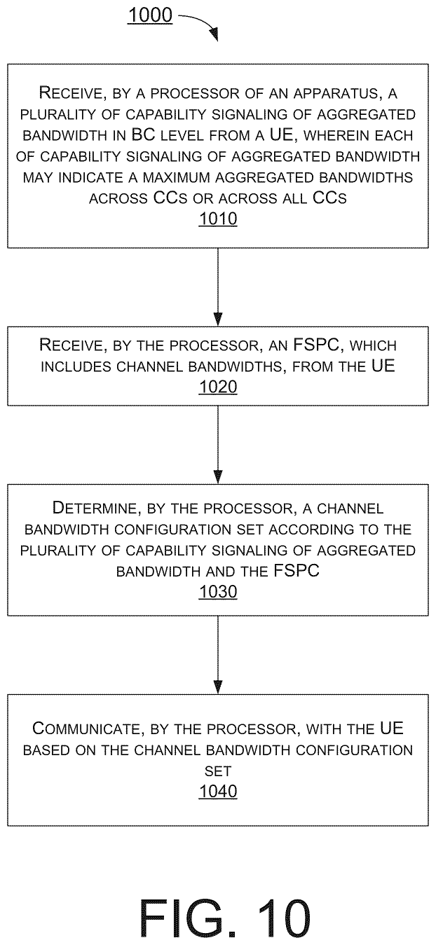

FIG. 10 illustrates an example process 1000 in accordance with an implementation of the present disclosure. Process 1000 may be an example implementation of above scenarios/schemes, whether partially or completely, with respect to carrier switch in cell of the present disclosure. Process 1000 may represent an aspect of implementation of features of network apparatus 820. Process 1000 may include one or more operations, actions, or functions as illustrated by one or more of blocks 1010 to 1040. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any suitable network device or machine type devices. Solely for illustrative purposes and without limitation, process 1000 is described below in the context of network apparatus 820. Process 1000 may begin at block 1010.

At block 1010, process 1000 may involve processor 822 of network apparatus 820 receiving a plurality of capability signaling of aggregated bandwidth in BC level from a UE. Each of capability signaling of aggregated bandwidth may indicate a maximum aggregated bandwidth across CCs. Process 1000 may proceed from block 1010 to block 1020.

At block 1020, process 1000 may involve processor 822 of network apparatus 820 receiving an FSPC, which includes channel bandwidths, from the UE. Process 1000 may proceed from block 1020 to block 1030.

At block 1030, process 1000 may involve processor 822 of network apparatus 820 determining a channel bandwidth configuration set according to the plurality of capability signaling of aggregated bandwidth and the FSPC. Process 1000 may proceed from block 1030 to block 1040.

At block 1040, process 1000 may involve processor 822 of network apparatus 820 communicating with the UE based on the channel bandwidth configuration set.

In some implementations, the plurality of capability signaling of aggregated bandwidth may include a capability signaling of TDD aggregated bandwidth. The capability signaling of TDD aggregated bandwidth may indicate a maximum aggregated bandwidth of a plurality of maximum aggregated bandwidths across TDD CCs.

In some implementations, the plurality of capability signaling of aggregated bandwidth may include a capability signaling of FDD aggregated bandwidth. The capability signaling of FDD aggregated bandwidth may indicate a maximum aggregated bandwidth of a plurality of maximum aggregated bandwidths across FDD CCs.

In some implementations, the plurality of capability signaling of aggregated bandwidth may include a capability signaling of total aggregated bandwidth. The capability signaling of total aggregated bandwidth may indicate a maximum total aggregated bandwidth of a plurality of maximum aggregated bandwidths across all CCs.

In some implementations, the plurality of capability signaling of aggregated bandwidth and the FSPC may be used for UL communication.

In some implementations, the plurality of capability signaling of aggregated bandwidth and the FSPC may be used for DL communication.

In some implementations, process 1000 may involve processor 822 of network apparatus 820 receiving a capability signaling of MIMO from the UE. The capability signaling of MIMO may indicate a maximum number of spatial multiplexing layers. Process 1000 may involve processor 822 of network apparatus 820 receiving the FSPC, which includes the channel bandwidths and spatial multiplexing layers, from the UE. Process 1000 may involve processor 822 of network apparatus 820 determining the channel bandwidth configuration set according to the plurality of capability signaling of aggregated bandwidth, the capability signaling of MIMO and the FSPC.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a plurality of capability signaling of aggregated bandwidth in band combination level to a network node, wherein each of capability signaling of aggregated bandwidth indicates a maximum aggregated bandwidth across component carriers;
transmitting, by the processor, a feature set per component-carrier, which includes channel bandwidths, to the network node for determining a channel bandwidth configuration set according to the plurality of capability signaling of aggregated bandwidth and the feature set per component-carrier; and
communicating, by the processor, with the network node based on the channel bandwidth configuration set.

2. The method of claim 1, wherein the plurality of capability signaling of aggregated bandwidth includes a capability signaling of time division duplexing aggregated bandwidth, and the capability signaling of time division duplexing aggregated bandwidth indicates a maximum aggregated bandwidth across time division duplexing component carriers.

3. The method of claim 1, wherein the plurality of capability signaling of aggregated bandwidth includes a capability signaling of frequency division duplexing aggregated bandwidth, and the capability signaling of frequency division duplexing aggregated bandwidth indicates a maximum aggregated bandwidth across frequency division duplexing component carriers.

4. The method of claim 1, wherein the plurality of capability signaling of aggregated bandwidth includes a capability signaling of total aggregated bandwidth, and the capability signaling of total aggregated bandwidth indicates a maximum total aggregated bandwidth across all component carriers.

5. The method of claim 1, wherein the plurality of capability signaling of aggregated bandwidth and the feature set per component-carrier are used for uplink communication.

6. The method of claim 1, wherein the plurality of capability signaling of aggregated bandwidth and the feature set per component-carrier are used for downlink communication.

7. The method of claim 1, further comprising:
transmitting, by the processor, a capability signaling of multi-input multi-output (MIMO) to the network node, wherein the capability signaling of MIMO indicates a maximum number of spatial multiplexing layers; and
transmitting, by the processor, the feature set per component-carrier, which includes the channel bandwidths and spatial multiplexing layers, to the network node for determining the channel bandwidth configuration set according to the plurality of capability signaling of aggregated bandwidth, the capability signaling of MIMO and the feature set per component-carrier.

8. A method, comprising:
receiving, by a processor of an apparatus, a plurality of capability signaling of aggregated bandwidth in band combination level from a user equipment, wherein each of capability signaling of aggregated bandwidth indicates a maximum aggregated bandwidths across component carriers;
receiving, by the processor, a feature set per component-carrier, which includes channel bandwidths, from the user equipment;
determining, by the processor, a channel bandwidth configuration set according to the plurality of capability signaling of aggregated bandwidth and the feature set per component-carrier; and
communicating, by the processor, with the user equipment based on the channel bandwidth configuration set.

9. The method of claim 8, wherein the plurality of capability signaling of aggregated bandwidth includes a capability signaling of time division duplexing aggregated bandwidth, and the capability signaling of time division duplexing aggregated bandwidth indicates a maximum aggregated bandwidth across time division duplexing component carriers.

10. The method of claim 8, wherein the plurality of capability signaling of aggregated bandwidth includes a capability signaling of frequency division duplexing aggregated bandwidth, and the capability signaling of frequency division duplexing aggregated bandwidth indicates a maximum aggregated bandwidth across frequency division duplexing component carriers.

11. The method of claim 8, wherein the plurality of capability signaling of aggregated bandwidth includes a capability signaling of total aggregated bandwidth, and the capability signaling of total aggregated bandwidth indicates a maximum total aggregated bandwidth across all component carriers.

12. The method of claim 8, wherein the plurality of capability signaling of aggregated bandwidth and the feature set per component-carrier are used for uplink communication.

13. The method of claim 8, wherein the plurality of capability signaling of aggregated bandwidth and the feature set per component-carrier are used for downlink communication.

14. The method of claim 8, further comprising:
receiving, by the processor, a capability signaling of multi-input multi-output (MIMO) from the user equipment, wherein the capability signaling of MIMO indicates a maximum number of spatial multiplexing layer;
receiving, by the processor, the feature set per component-carrier, which includes the channel bandwidths and spatial multiplexing layers, from the user equipment; and
determining, by the processor, the channel bandwidth configuration set according to the plurality of capability signaling of aggregated bandwidth, the capability signaling of MIMO and the feature set per component-carrier.

15. An apparatus, comprising:
a transceiver which, during operation, wirelessly communicates with a network node; and
a processor communicatively coupled to the transceiver such that, during operation, the processor performs operations comprising:
transmitting, via the transceiver, a plurality of capability signaling of aggregated bandwidth in band combination level to the network node, wherein each of capability signaling of aggregated bandwidth indicates a maximum aggregated bandwidth across component carriers;
transmitting, via the transceiver, a feature set per component-carrier, which includes channel bandwidths, to the network node for determining a channel bandwidth configuration set according to the plurality of capability signaling of aggregated bandwidth and the feature set per component-carrier; and
communicating, via the transceiver, with the network node based on the channel bandwidth configuration set.

16. The apparatus of claim 15, wherein the plurality of capability signaling of aggregated bandwidth includes a capability signaling of time division duplexing aggregated bandwidth, and the capability signaling of time division duplexing aggregated bandwidth indicates a maximum bandwidth across time division duplexing aggregated component carriers.

17. The apparatus of claim 15, wherein the plurality of capability signaling of aggregated bandwidth includes a capability signaling of frequency division duplexing aggregated bandwidth, and the capability signaling of frequency division duplexing aggregated bandwidth indicates a maximum aggregated bandwidth across frequency division duplexing component carriers.

18. The apparatus of claim 15, wherein the plurality of capability signaling of aggregated bandwidth includes a capability signaling of total aggregated bandwidth, and the capability signaling of total aggregated bandwidth indicates a maximum total aggregated bandwidth across all component carriers.

19. The apparatus of claim 15, wherein the plurality of capability signaling of aggregated bandwidth and the feature set per component-carrier are used for uplink or downlink communication.

20. The apparatus of claim 15, wherein, during operation, the processor further performs operations comprising further comprising:
transmitting, via the transceiver, a capability signaling of multi-input multi-output (MIMO) to the network node, wherein the capability signaling of MIMO indicates a maximum number of spatial multiplexing layers; and
transmitting, via the transceiver, the feature set per component-carrier, which includes the channel bandwidths and spatial multiplexing layers, to the network node for determining the channel bandwidth configuration set according to the plurality of capability signaling of aggregated bandwidth, the capability signaling of MIMO and the feature set per component-carrier.
